(19) United States
(12) Patent Application Publication
(10) Pub. No.: US 2012/0316898 A1
(43) Pub. Date: Dec. 13, 2012

(54) SCALABLE DETERMINATION OF PROBABLE PATIENT ELIGIBILITY FOR CLINICAL TRIALS AND ASSOCIATED PROCESS FOR ACTIVE SOLICITATION OF PATIENTS FOR CLINICAL TRIALS VIA THEIR HEALTHCARE PROVIDERS

(76) Inventors: Tod S. Levitt, East Setauket, NY (US); Michael Edward Lundie, Watkinsville, GA (US)

(21) Appl. No.: 13/492,450

(22) Filed: Jun. 8, 2012

Related U.S. Application Data
(60) Provisional application No. 61/494,699, filed on Jun. 8, 2011.

(51) Int. Cl. G06Q 50/24

(52) U.S. Cl. 705/3

(57) ABSTRACT

This twenty-step business process uses a clinical trials matching system to perform scalable searches of derived patient data records for patients that may be eligible for clinical trials. The patent-bearing business contracts with healthcare providers of patients found in derived patient data records to review the likely matches of those patients to clinical trials. Contracted healthcare providers also provide sufficient data for the patent-bearing business to determine if their patients qualify for clinical trials. Probabilistic matching techniques are used for this determination. The healthcare provider solicits qualified patients for clinical trials and interacts to enroll patients in trials. Solicitation is active in that the patent bearing business need not wait for a patient to initiate contact in order to seek determination of a patient's potential eligibility to participate in a clinical trial. Patient privacy is protected by limiting patient contact to be only through the patient's healthcare provider.

### CROSS REFERENCE TO RELATED APPLICATIONS

This application claims benefit of Provisional Patent Application No. US 61/494,699 titled “Scalable, Active Solicitation of Healthcare Providers and their Associated Patients for Participation in Clinical Trials” filed with USPTO 8 Jun. 2011.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDICES

Not Applicable

### BACKGROUND OF THE INVENTION

The field of endeavor to which the invention pertains is to medical information processing systems, in particular for a computerized, internet-based business process for actively identifying patients and soliciting Healthcare Providers to engage their patients in participating in clinical trials, and to a system for matching patient demographic and medical data and derived patient data, such as medical insurance records, that is necessary to enable the business process.

At any given time there are many thousands of U.S. and international clinical trials soliciting for qualified patients. Most of these trials concern pharmaceutical drugs and therapies for diseases and for other significant medical conditions. The time it takes to find qualified patients for trials routinely causes significant delays in bringing therapies and cures to market and is therefore extraordinarily costly in suffering to the persons that need these drugs and therapies, and costly in financial terms to pharmaceutical and related manufacture and delivery companies, as well as being costly to the persons, insurance agencies, national governments and other entities that provide funds and care to those afflicted.

Patient privacy laws, particularly in the United States, prohibit active solicitation of patients for clinical trials by those responsible to solicit and execute those trials. For example it is not allowed to use an active solicitation method such as using information derived from insurance claims records to send clinical trial solicitation notices to patients who are likely to suffer from a particular disease. Passive solicitation methods such as advertising and medical condition related web portals provide a means for individual patients to initiate contact with those businesses that enroll patients in clinical trials. Passive solicitation methods depend upon random chance that patients with the correct set of medical conditions encounter the relevant trials solicitations. Passive solicitation also depends upon patients to be knowledgeable or curious about the possible benefits of participating in a clinical trial, and to have the means and knowledge to pursue those solicitations. In addition many clinical trials depend upon finding patients who reside in physical proximity to the site(s) of clinical trial administration, thereby greatly reducing the relevant patient population and the corresponding chances of passively soliciting those patients for the relevant trials.

When a patient's qualified healthcare provider deems it medically appropriate, the healthcare provider has the legal right to recommend participation in a clinical trial to their patient. However given the large volume of clinical trials that are soliciting at any time, it is a difficult and time-consuming activity for a healthcare provider to maintain cognizance of clinical trials that may be relevant to their patient population, and an even more time consuming and often complex activity to determine if a given patient may qualify for a given clinical trial. For these reasons healthcare providers by and large do not seek out nor recommend clinical trial participation to their patients.

There are multiple and various patented systems that match patient medical record data to clinical trial requirements. However none of these systems address the business process issue of how the patient medical data is made available to the matching system. In addition none of these systems use probabilistic matching methods that can account for estimation of the certainty with which a patient is likely to qualify for a trial in the event that not all the relevant data is available to the system.

There are multiple sources of patient demographic and medical and pharmaceutical data that provide partial or implied information about a patient's medical condition. These sources include but are not limited to medical insurance claims, drug insurance claims and hospital emergency room records. Collectively we call such information “derived patient data” indicating that it is derivative of information in the full patient medical record.

In seeking patients that may qualify for clinical trials it is highly desirable to leverage derived patient data as an initial part of the process in searching for patients that may qualify for clinical trials. This is because there are vast, electronically available sources of such data that are readily searchable, the derived patient data is almost always sufficient to determine relevant physical proximity between patients and trials, and it does not require taking the time of healthcare providers.

Derive patient data is large-scale in that there are many millions of such records that are accumulated every day, so any method that would match patients to trials using derived patient data must be automated and be scalable in processing.

In addition, because a derived patient data record is fragmentary with respect to a patient's medical condition and treatment history, it is necessary to have a matching method that can determine the likelihood that patient may match a trial without necessarily being able to qualify that patient with certainty.

### BRIEF SUMMARY OF THE INVENTION

The invention provides a business process and a supporting Internet-enabled computer system to perform scalable analysis of computerized records and solicitation of Healthcare Providers to determine if one or more of a solicited Healthcare Provider's patients qualify for participation in a clinical trial and if so, to enroll them in a trial.

Although patients cannot be actively solicited for clinical trials, it is allowed to actively solicit healthcare providers. A contract can be made with healthcare providers to formally involve them in the process of identifying patients that may qualify for clinical trials and enrolling the qualified patient. Derived patient data can be used to find patients that may be eligible to participate in a clinical trial and to find a healthcare provider for that patient. Subsequently the healthcare provider can both provide additional patient data and can actively solicit the qualified patient to enroll in a clinical trial.

Because derived data is fragmentary relative to a patient medical record it is both necessary to have a method for matching derived patient data against clinical trial eligibility criteria that tolerates uncertainty and missing information. A probabilistic matching approach can fulfill this need, and is used in this business process.

The probabilistic matching method only depends upon the derived patient data and the clinical trial eligibility criteria. Consequently the matching method can be employed in parallel on multiple processors and thereby cost-effectively scale to doing millions of matches per hour.

When a healthcare provider is under contract, additional patient data is requested that is sufficient to determine if a patient, matched to a trial from derived patient data, is actually qualified to participate in the trial.

The same probabilistic matching method is used with the additional data provided by the healthcare provider to determine if the patient is qualified for the clinical trial.

When a match of a patient to a clinical trial is confirmed, the healthcare provider is so notified and subsequently contacts the patient to solicit them to enroll in the clinical trial.

Once the patient is enrolled in the trial, via contact with a Clinical Trial Administrator, Clinical Trials Broker or Clinical Trials Supplier as appropriate, then the Clinical Trials Brokerage remunerates the Patent-Bearing Business and Healthcare Provider.

### BRIEF DESCRIPTION OF THE SEVERAL VIEWS OF THE DRAWINGS

FIG. 1 is a an exemplar work-flow diagram showing the Steps in the business process as transactions between the Clinical Trial to Patient Matching Business, Derived Patient-Data Supplier, Clinical Trials Supplier, Clinical Trials Brokerage, Clinical Trial Administrator and the Healthcare Provider.

FIG. 2 is a matrix showing the kinds of businesses that fulfill the business roles indicated by the business types shown in FIG. 1.

FIG. 3 shows the clinical trial to derived patient-data record matching method for taking inputs from a derived patient data source and determining whether the patient associated to the claim is probabilistically likely to match the criteria for a participation in a clinical trial. Using the same terms alignment and probabilistic matching method, additional patient data, such as might be obtained from an electronic medical record, is used to determine the likelihood that a patient qualifies for participation in a clinical trial.

### DETAILED DESCRIPTION OF THE INVENTION

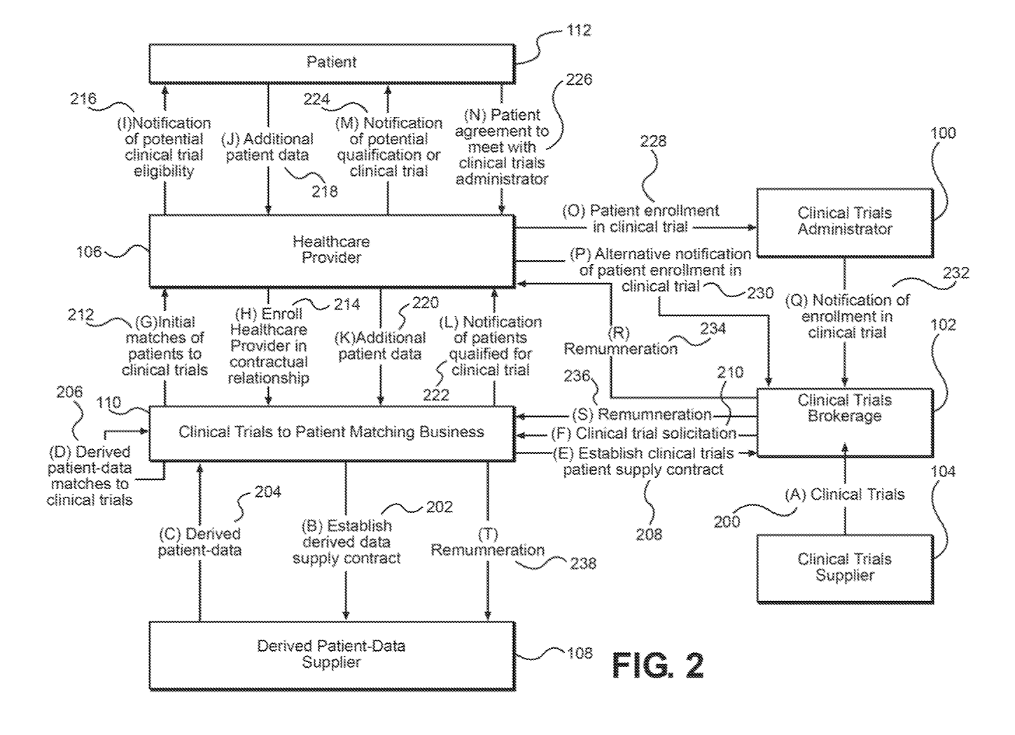

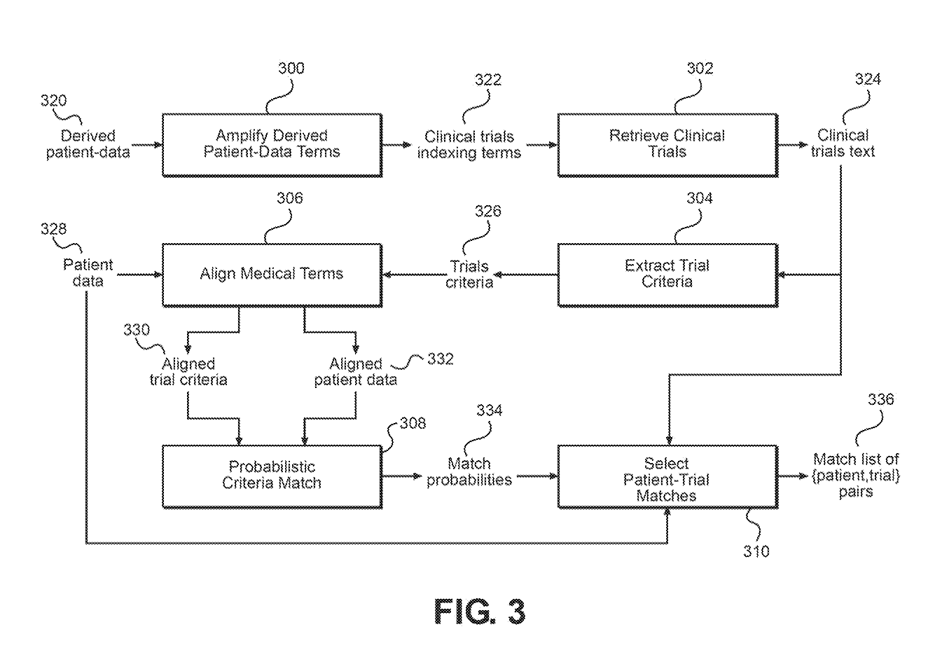

The goal of the business process pictured in FIG. 2 and its associated probabilistic matching method pictured in FIG. 3 is to actively seek out and enroll patients in clinical trials.

The business process [FIG. 2] is comprised of multiple steps. Each step is denoted in FIG. 2 as an arrow representing a transaction between two business entities, or between a patient and his or her healthcare provider along with the information or remuneration associated to the transaction.

The process may require as many as twenty steps as pictured in FIG. 2, but the process is embodied by the results of the transactions such that variations in the ordering of the steps of FIG. 2, or combining of steps so that multiple transactions are combined into one, or separation of a single transaction into multiple transactions that achieve the same transmission or information or remuneration between business entities pictured in FIG. 2 are considered altogether to be the same process.

A person is said to be eligible, or equivalently, potentially qualified, for a clinical trial if they meet the eligibility criteria listed in the clinical trial. A person is said to be qualified for a clinical trial when a business entity called a Clinical Trials Administrator [100] determines that the person is eligible for the clinical trial and seeks to enroll the person in the clinical trial. The box labeled Patient [112] in FIG. 2 represents a person who has been determined to be a probable, but not necessarily eligible, candidate for a clinical trial. The other boxes in FIG. 2 represent business entity types that have specific roles in the business process.

In an embodiment of the business process of FIG. 2 a single business entity may perform one or more of the roles of the business entities pictured in FIG. 2. For example a business entity that is a Clinical Trials Supplier [104] may also perform the role of brokering its own clinical trials and thus also be a Clinical Trials Brokerage [102]. In that case the transaction (A) [200] in FIG. 2 that occurs between them is considered to be implicitly accomplished. Altogether in an embodiment where one or more business entities performs more than one role, and there are consequently one or more implicitly accomplished transactions, the process altogether is still considered to be the same business process.

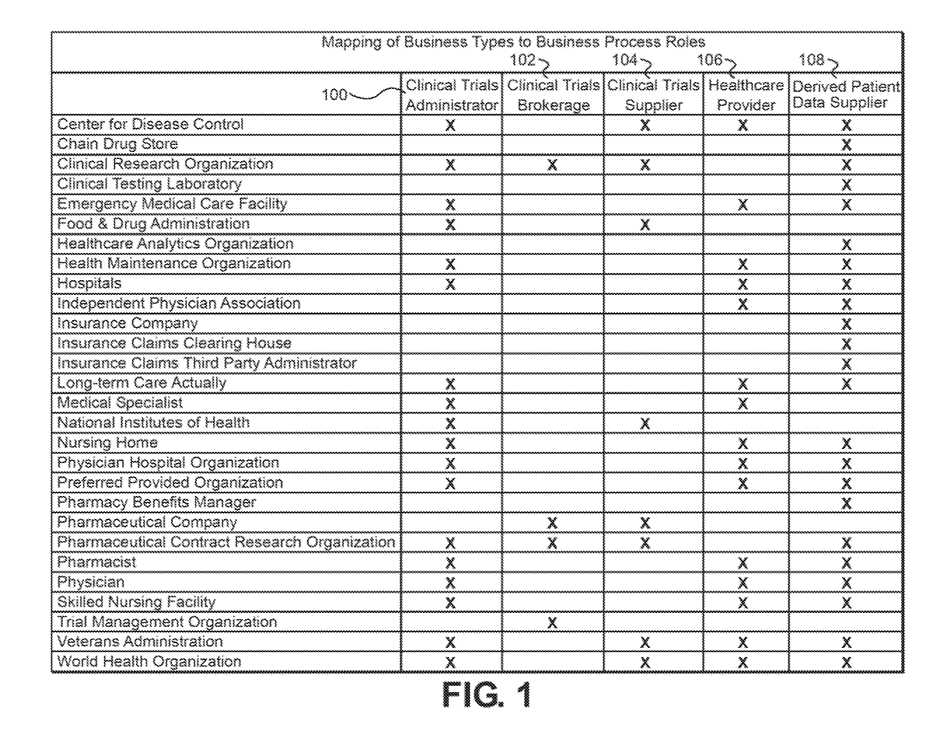

The table in FIG. 1 lists some, but not necessarily all, businesses that can be embodiments of the business entities of FIG. 1 including the Clinical Trials Administrator [100], the Clinical Trials Brokerage [102], the Clinical Trials Supplier [104], the Healthcare Provider [106] and the Derived Patient Data Supplier [108].

The business entities of FIG. 2 each perform functions and transactions in the business process of FIG. 2. The letters in parentheses (A) through (T) indicate the order in which transactions between business entities are expected to take place. If the order is varied but the outcomes of engaging in transactions are the same, then such ordering would also be considered to be an embodiment of the same business process.

The business process of FIG. 2 is comprised of functions and transactions as follows. A Clinical Trial Supplier [104] develops Clinical Trials [200] and contracts with a Clinical Trials Brokerage [102] to find one or more Patients [112] to participate in the trial. The Clinical Trials Brokerage [102] in turn contracts with a Clinical Trials Administrator [100] to qualify and enroll patients in the clinical trial. The Clinical Trials to Patient Matching Business [110], which is also called the patent-bearing business, contracts with the Clinical Trials Brokerage [102] to provide patients to participate in the clinical trial [208]. The Clinical Trials Brokerage [102] provides a clinical trials solicitation [210] to the Clinical Trials to Patient Matching Business [110]. The Clinical Trials to Patient Matching Business contracts [202] with a Derived Patient-Data Supplier [108] to obtain derived patient-data [204] from which it uses the probabilistic matching method of FIG. 3 to determine patients that may possibly be eligible for the clinical trial [206]. From the derived patient data the Clinical Trials to Patient Matching Business [110] can identify the patient's Healthcare Provider [106], notify the Healthcare Provider [106] of initial matches of patients to clinical trials [212] and contract [214] with the Healthcare Provider [106]. The Healthcare Provider contacts the Patient [112] to notify them of potential clinical trial eligibility [216]. The Patient [112] provides additional patient data [218] either from their medical record or by direct interaction with the Healthcare Provider [106]. The additional patient data [220] is supplied to the Clinical Trials to Patient Matching Business [110]. The Clinical Trials to Patient Matching Business [110] uses the probabilistic matching method of FIG. 3 to determine if the Patient [112] is eligible for the clinical trial or not. The Clinical Trials to Patient Matching Business [110] notifies the Healthcare Provider [106] if the patient potentially qualifies for the clinical trial [222]. The Healthcare Provider [106] notifies [216] the Patient [112] that they may be potentially qualified [224] and interacts with the Patient [112] to obtain Patient [112] agreement [226] to meet with the Clinical Trials Administrator [100]. The Clinical Trials Administrator [100] determines if the Patient [112] is qualified for the trial and if so, enrolls [228] the Patient [112] in the trial. The Clinical Trial Administrator [100] subsequently notifies[232] the Clinical Trials Brokerage [102] that the Patient [112] is enrolled. Alternatively the Healthcare Provider [106] notifies [230] the Clinical Trials Brokerage that the Patient [112] is enrolled in the clinical trial. The Clinical Trials Brokerage [102] remunerates the Healthcare Provider [106] and the Clinical Trials to Patient Matching Business [110]. Then the Clinical Trials to Patient Matching Business [110] remunerates the Derived Patient-Data Supplier [108].

Derived patient-data is data that contains only part of the data in a patient's medical record retained by a healthcare provider. The derived patient data provided by a derived patient-data supplier is anonymized by use of an identifier known to the healthcare provider identified in the derived patient-data. This allows the clinical trials to patient matching business to communicate with the healthcare provider about the patient without compromising patient privacy.

Selected parts of the derived patient-data records [320] are processed by the probabilistic matching method of FIG. 3. The probabilistic matching method is a computer program that takes as input a derived patient-data record [320] and the demographic and inclusion and exclusion criteria for participation in a clinical trial, together called the trials criteria [326] and produces a probability between zero and one inclusive that the patient is eligible for the clinical trial.

Because the processing of any one derived patient-data record does not depend on the results of processing any other records, by adding a number, N, of additional computers or computer processing units, then N records can be matched to the clinical trial in the same time it takes one computer or computer processing unit to match one record. This is what is meant by “scalable”.

When the patient associated with a derived patient-data record matches to a clinical trial with sufficiently high probability the system checks the identity of the Healthcare Provider [106] listed in the derived patient-data record against a list of Healthcare Providers already contracted to with the Clinical Trials to Patient Matching Business [110].

If the Healthcare Provider [106] is not contracted then the business process proceeds as indicated in FIG. 2 starting from transaction [212].

If the Healthcare Provider is already contracted with the Clinical Trials to Patient Matching Business then the Clinical Trials to Patient Matching Business contacts the Healthcare Provider over the internet either by sending an email to the Healthcare Provider or by sending an alert to the clinical trials computer program already installed at the Healthcare Provider's office.

The Clinical Trials to Patient Matching Business also uploads over the internet a summary about the initial match [212] either to a website or to the Healthcare Provider's clinical trials computer program. The Healthcare Provider then can either use a web browser to view the patient match on the website or by opening the clinical trials computer program installed on a computer in his or her office.

By making interactive selections either on the website or the clinical trials computer program, the Healthcare Provider can either submit additional patient data [220] to the Clinical Trials to Patient Matching Business. Parts of this data [328], along with parts of the derived patient-data [320] and the text from the clinical trial [324] are the inputs to the probabilistic matching method pictured in FIG. 3.

Derived patient data [320] contains terms and phrases and sentences referring to demographics, biological status, medical conditions, medical diseases, drugs and therapies. These terms and phrases and sentences are not necessarily the same as those used in the inclusion and exclusion clauses associated to a clinical trial. In step [300] of the method of FIG. 3 the terms and the terms in phrases and sentences are amplified by being associated to other closely related terms that are commonly found in clinical trials. These are called clinical trials indexing terms [322] because they can be used to search for clinical trials among those provided by the Clinical Trials Brokerage for those that contain the same terms. From these clinical trials the text [324] associated to patient eligibility inclusion and exclusion criteria is identified. From the clinical trials text [324] the process [304] extracts the specific inclusion and exclusion criteria [326].

The trials criteria [326] and the patient data [328] are aligned in process [306]. This alignment matches up the terms in each that are the same, resulting in trial criteria [330] that are aligned, i.e. likely to mean the same thing, as in parts of the medical record and in patient data [332] that is aligned, i.e. likely to mean the same thing, as in the trials criteria. A probabilistic criteria matching process [308] is used to quantify ambiguity in matching of aligned patient data and aligned trial criteria terms to produce a number between zero and one that is the match probabilities [334] that the patient is eligible for one or more of the clinical trials. A process [310] selects sufficiently high probability matches producing a list of zero or more {patient, trial} match pairs [336].

The process applying the probabilistic match criteria [308] is consistent with the axioms of probability theory in determining a single number between zero and one that is the probability that the patient meets the inclusion and exclusion criteria required to participate in the clinical trial.

What is claimed is:

1. A system and corresponding business process for identifying and enrolling prospective participants in one or more clinical trials in twenty Steps comprising a set of contracts and interactions between six types of businesses of the following sorts:
Clinical Trials Supplier: a business that generates clinical trials and funds other businesses to help it carry out the trials;
Clinical Trials Brokerage: a business that contracts with Clinical Trials Suppliers to find patients qualified for the clinical trials and arranges for their enrollment in the trials;
Derived Patient-Data Supplier: a business that has large stores (i.e. thousands or more) of computerized records including but not limited to medical insurance claim data, pharmacy insurance claims data, prescription data, clinical test lab data or incidental (i.e. non-primary) patient care data such as emergency room records, most of such data being characterized as providing only partial medical information about any patient generally insufficient to determine whether the patient completely fits all clinical trial requirements; herein such data is called “derived patient-data”;
Clinical Trials to Patient Matching Business: the business that exercises the business process and clinical trials matching system that is the subject of this patent;
Healthcare Provider: a business or person that provides medical care directly to patients, has or can obtain medical data about those patients sufficient to determine if they qualify for clinical trials, and which is legally allowed to provide those patients with the opportunity to participate in clinical trials;
Clinical Trials Administrator: a business that participates with the Clinical Trials Brokerage to enroll patients in a clinical trial and then conducts the trial with the patients.

2. The twenty Step business process of claim 1 is further comprised of the following Steps:
Step A: a Clinical Trials Supplier contracts to a Clinical Trials Brokerage to find and arrange for the enrollment of patients in one or more clinical trials;
Step B: the Clinical Trials to Patient Matching Business establishes a contract with one or more Derived Patient-Data Suppliers to supply derived patient data;
Step C: a Derived Patient-Data Supplier provides anonymized derived patient-data to the Clinical Trials to Patient Matching Business—each such anonymized patient record contains the contact information for the patient's Healthcare Provider;
Step D: the Clinical Trials to Patient Matching Business matches derived patient data against sources of extant clinical trials to find clinical trials for which there are likely to be qualified patients as indicated by partial matching to the clinical trials qualification criteria;
Step E: the Clinical Trials to Patient Matching Business contacts the Clinical Trials Brokerage that is enrolling patients for clinical trials discovered in Step 4, and establishes a contract with the Clinical Trials Brokerage to supply patients for clinical trials for which the Clinical Trials Brokerage will solicit patients from the Clinical Trials to Patient Matching Business; Note also that this contact can be established without performing Step 4;
Step F: a Clinical Trials Brokerage solicits the Clinical Trials to Patient Matching Business and provides one or more clinical trials for which it needs patients;
Step G: the Clinical Trials to Patient Matching Business searches the derived patient data to find patients that are likely to be matches to the clinical trial requirements, then for each such initial match contacts the patient's Healthcare Provider to notify them that the patient may be a match to the trial and in the event they have not already done so, offers the Healthcare Provider a contractual relationship;
Step H: the Clinical Trials to Patient Matching Business enrolls the Healthcare Provider in the contractual relationship to participate in finding and enrolling patients in clinical trials;
Step I: The Healthcare Provider contacts the Patient who may be eligible to participate in a clinical trial and solicits permission to use their medical record data to determine if they are eligible for the clinical trial and may also solicit additional information from the Patient to sufficient to make the determination.
Step J: The Patient provides permission and may provide in addition data to the Healthcare Provider.
Step K: The Healthcare Provider provides additional patient data to the Clinical Trials to Patient Matching Business sufficient for the Clinical Trials to Patient Matching Business to determine whether or not the Patient meets the eligibility requirements for the clinical trial to which they were initially matched, and the Clinical Trials to Patient Matching Business makes that determination;
Step L: The Clinical Trials to Patient Matching Business notifies the Healthcare Provider of patients that meet the eligibility requirements for clinical trials.
Step M: The Healthcare Provider notifies each eligible patient to see if they wish to participate in the clinical trial;
Step N: The Patient provides agreement to meet with the Clinical Trials Administrator.
Step O: The Healthcare Provider contacts the Clinical Trials Administrator indicated by the Clinical Trials to Patient Matching Business to enroll the patient in the clinical trial;
Step P: Alternatively the Healthcare Provider notifies the Clinical Trials Brokerage to arrange for the Patient to be qualified and enrolled in the clinical trial.
Step Q: The Clinical Trials Administrator notifies the Clinical Trial Brokerage that the Patient is enrolled in the clinical trial.
Step R: The Clinical Trials Brokerage remunerates the Healthcare Provider.
Step S: The Clinical Trials Brokerage remunerates the Clinical Trials to Patient Matching Business.
Step T: The Clinical Trials to Patient Matching Business remunerates the Derived Patient-Data Supplier.

3. In the method of Step D of claim 2 the automated processing of unformatted textual data that is part of the description of patient demographic, inclusion and exclusion clinical trial qualification criteria.

4. In the method of Step D of claim 2 the use automated methods to match to the terms used in describing the inclusion and exclusion criteria for clinical trials the terms associated to the following items: insurance diagnosis codes, specialty and location of the Healthcare Provider, geographic information derived through zip codes, patient age and patient gender.

5. In the method of Step D of claim 2 that the automated matching is a parallelizable computing operation so that the automated matching enables parallel, and therefore scalable, searches of Derived Patient-Data for prospective clinical trial participants, i.e. by adding a number, N, more computer processing units running the same matching program, N times as many Derived Patient-Data can be processed per unit time as can be processed on a single computer processing unit.

6. In the method of Step D of claim 2 the use of a probability model, subjective probability estimates and other statistical data and heuristics to determine the likelihood that a patient meets the criteria for a clinical trial.

7. In the method of Step D of claim 2 the use a mathematical function of the likelihood of claim, such as a threshold or a decision-theoretic utility function, to determine whether or not to contact Healthcare Providers who have one or more patients likely to qualify for one or more clinical trials.

8. In the method of Step K of claim 2 the use of the internet-enabled computer program and user interface for the Healthcare Provider to submit additional patient information.

9. In the method of Step K of claim 2 the use of automated methods to match the additional patient data to the inclusion and exclusion criteria for a clinical trial and to determine if the patient is eligible for participation in the clinical trial or not.

10. In the method of Step K of claim 2 the use of a probability model, subjective probability estimates and other heuristics to determine the likelihood that a patient meets the criteria for a clinical trial.

11. In method of Step L of claim 2 the use of the internet-enabled computer program of claim 8 to notify the Healthcare Provider whether or not a patient qualifies for a clinical trial as determined in claim 12 or claim 14.

12. In the method of Step L of claim 2 the use of either an electronic web form sent over the internet and opened in a web browser, or the use of the Internet-enabled computer program of claim 8 to enable the Healthcare Provider to submit a patient for participation in a clinical trial.

13. That in all the Steps of the method of claim 2, that until the patient legally agrees to participate in the clinical trial, only the Healthcare Provider who already provides medical services for the patient ever directly contacts that patient with respect to the possibility of participating in a clinical trial, and thereby protects patient privacy.
